(19) United States
(12) Patent Application Publication
(10) Pub. No.: US 2023/0204266 A1
(43) Pub. Date: Jun. 29, 2023

(54) TRACKER FOR MONITORING A DISCHARGE OF A FLUID FROM A TANK

(71) Applicant: Christopher Franzese, Sunrise, FL (US)

(72) Inventor: Christopher Franzese, Sunrise, FL (US)

(21) Appl. No.: 17/565,335

(22) Filed: Dec. 29, 2021

(51) Int. Cl. F25B 40/02; F25B 49/02; G01N 11/02

(52) U.S. Cl. CPC F25B 40/02; F25B 49/022; G01N 11/02

(57) ABSTRACT

A tracker for monitoring a discharge of a fluid from a tank includes a conduit adapted to supply the fluid to an appliance from the tank and at least one sensor adapted to determine one or more parameters of the fluid flowing through conduit. The tracker also includes a location sensor, and a controller configured to determine a discharge event of the fluid from the tank based on the one or parameters and calculate a total amount of the fluid discharged from the tank based on the one or more parameters during the discharge event. The controller is also configured to determine a location of the tracker during the discharge event and associate the location of the tracker with the discharge event.

### FIELD OF THE INVENTION

The present disclosure relates, generally, to a tracker, and more particularly relates to a tracker suitable for tracking a discharge of a fluid from a tank.

### BACKGROUND OF THE INVENTION

Refrigerant is an essential substance in air conditioning unit to function properly, and it is an expensive one. Technicians on the field filling refrigerants in customer's air conditioning units may, for various, reasons lose track of the quantity of refrigerants filled in each air conditioning unit. Also, some amount of refrigerant may go unaccounted due to losses, unintended dispensation, or may be simply stolen, which is undesirable.

Moreover, typically, a tank will be enough to fill few air conditioning units, but it is hard to know exactly how many as each air conditioning unit is different. Moreover, some air conditioning unit may need only little refrigerant, while some air conditioning units are near empty, and thus require large amount of refrigerant. Therefore, for better accounting and customer's relationship, the owner of the AC repair business would appreciate a better control of amount of refrigerant actually being dispensed at each air conditioning unit.

### SUMMARY

Embodiments of the disclosure provide a tracker for monitoring a discharge of a fluid, for example, a refrigerant from a tank. The tracker includes a conduit adapted to be fluidly connected with an outlet of the tank to supply the fluid to an appliance from the tank, and at least one sensor adapted to determine one or more parameters of the fluid flowing through conduit. The tracker also includes a location sensor adapted to detect a location of the tracker and a controller in communication with the at least one sensor and the location sensor. The controller is configured to determine a discharge event of the fluid from the tank based on the one or parameters determined by the at least one sensor, and calculates a total amount of the fluid discharged from the tank based on the one or more parameters determined by the at least one sensor during the discharge event. The controller is further configured to determine a location of the tracker during the discharge event and associate the location of the tracker with the discharge event.

In some embodiments, the at least one sensor includes a flow sensor to determine a flow rate of the fluid through the conduit.

In some embodiments, the controller determines the total amount of fluid discharged from the tank during the discharge event based on the flow rate determined by the flow sensor.

In some embodiments, the tracker is associated with the tank by entering a tank identification number into the tracker.

In some embodiments, the tracker includes a transceiver to facilitate a sharing of data measured by the tracker with a central station.

In some embodiments, the tracker further includes a user interface having a display to show at least one of a location of the tracker, the one or more parameters measured by the at least one sensor, and the total amount of fluid discharged from the tank.

In some embodiments, the at least one sensor includes a pressure sensor to monitor a pressure of the fluid flowing through the conduit.

In some embodiments, the tracker further includes an accelerometer to detect a movement of the tracker.

In some embodiments, the fluid is a refrigerant.

In accordance with an embodiment, a tank assembly is provided. The tank assembly includes a tank adapted to store a fluid to facilitate a filling of the fluid in an appliance, and a tracker mounted to the tank and adapted to monitor a discharge of the fluid from the tank. The tracker includes a conduit adapted to be fluidly connected with an outlet of the tank to supply the fluid to the appliance from the tank, and at least one sensor adapted to determine one or more parameters of the fluid flowing through conduit. The tracker also includes a location sensor adapted to detect a location of the tracker, and a controller in communication with the at least one sensor and the location sensor. The controller is configured to determine a discharge event of the fluid from the tank based on the one or parameters determined by the at least one sensor, and calculate a total amount of the fluid discharged from the tank based on the one or more parameters determined by the at least one sensor during the discharge event. The controller is also configured to determine a location of the tracker during the discharge event and associate the location of the tracker with the discharge event.

In some embodiments, the at least one sensor includes a flow sensor to determine a flow rate of the fluid through the conduit.

In some embodiments, the controller determines the total amount of fluid discharged from the tank during the discharge event based on the flow rate determined by the flow sensor.

In some embodiments, the tracker is associated with the tank by entering a tank identification number into the tracker.

In some embodiments, the tracker includes a transceiver to facilitate a sharing of a data measured by the tracker with a central station.

In some embodiments, the tracker includes a user interface having a display to show at least one of a location of the tracker, the one or more parameters measured by the at least one sensor, and the total amount of fluid discharged from the tank.

In some embodiments, the at least one sensor includes a pressure sensor to monitor a pressure of the fluid flowing through the conduit.

In some embodiments, the tracker includes an accelerometer to detect a movement of the tracker.

In some embodiments, the fluid is a refrigerant.

### BRIEF DESCRIPTION OF THE ACCOMPANYING DRAWINGS

Having thus described example embodiments of the present disclosure in general terms, reference will now be made to the accompanying drawings, which are not necessarily drawn to scale, and wherein:

FIG. 1 illustrates a tracking system having a plurality of tank assemblies and a mobile device having web-based application arranged in the vicinity of the tank assemblies and in communication with trackers of the tank assemblies.

FIG. 2 illustrates a schematic view of the tracker showing internal components of the tracker;

FIG. 3 illustrates a schematic view of the tracker depicting a user interface of the tracker;

FIG. 4 illustrates a schematic view of the web-based application depicting a user interface of the web-based application; and

FIG. 5 illustrates the tank assembly connected with an appliance for filling a fluid from the tank to the appliance.

### DETAILED DISCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, apparatus and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. The use of any term should not be taken to limit the spirit and scope of embodiments of the present invention.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

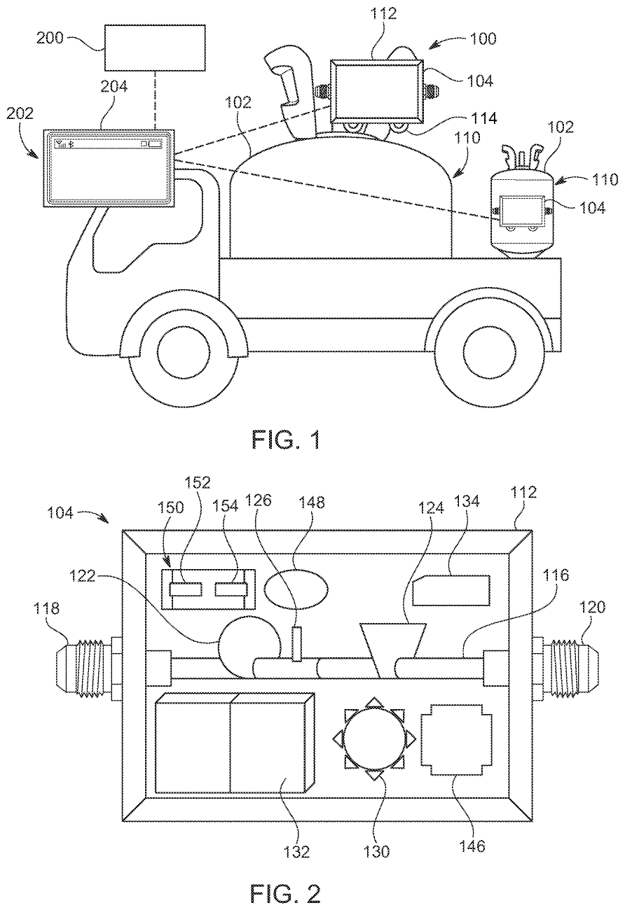

FIG. 1 shows a tracking system 100 for monitoring and tracking discharge of a fluid, for example, a refrigerant, such as hydrofluorocarbons (HFC), chlorofluorocarbons (CFC), or hydrochlorofluorocarbons (HCFC), etc., from one or more tanks 102 in which the fluid is stored. The tracking system 100 includes at least one tracker 104 attached to tank 102 and a central station 200 arranged remotely from the tracker 104 and can be accessed by a web-based application 204 installed in a computing device, for example, a mobile device 202 or a tablet, of the technician. The central station 200 is adapted to communicate with the all the trackers 104 present is the vicinity of the mobile device having the web-based application 204. For monitoring the discharge of the fluid from each of the tank 102, one tracker 104 is removably attached to one tank 102, and therefore, together define a tank assembly 110. In an embodiment, the tracker 104 is integrally attached with the tank 102 and is connected with an outlet of the tank 102.

The tracker 104 includes a housing 112 having at least one bracket 114 that facilitates a removable mounting of the tracker 104 on the tank 102. As shown in FIG. 2, the tracker 104 includes a conduit 116 extending through the housing 112 and having an inlet portion 118 arranged outside the housing 112 and adapted to be coupled with the tank 104 and an outlet portion 120 arranged outside the housing 112 and adapted to be coupled with an appliance, for example, an air-conditioning unit in which the gas is to be filled. The conduit 116 receives the fluid from the tank 102 via the inlet portion 118 and provide the fluid to the appliance through the outlet portion 120. It may be appreciated that the inlet portion 118 and the outlet portion 120 are, respectively, coupled with the tank 102 and the appliance with suitable pipes. In an embodiment, the pipe connecting the outlet portion 120 to the appliance may include a pressure gauge to monitor the pressure of the fluid being filling in the appliance.

The tracker 104 further includes at least one sensor, for example, a flow sensor 122, a pressure sensor 124, and a temperature sensor 126, to detect a flow rate, a pressure, and a temperature, respectively, of the fluid flowing through the conduit 116. The flow sensor 122 is adapted to facilitate a determination of amount of fluid flowing through the conduit, while the pressure sensor 124 detects a pressure of the fluid inside the conduit 116. Similarly, the temperature sensor 126 monitors a temperature of the fluid flowing through the conduit 116. Further, the tracker 104 includes a location sensor 130 to track a location of the tank assembly 110 or the tracker 104. In an embodiment, the location sensor 130 may include a GPS (geo positioning system) unit arranged inside the housing 112. Although the GPS unit is contemplated as the location sensor 130, it may be appreciated that any other type of location sensor, for example, GLONASS sensor, or any other suitable sensor known in the art may also be utilized. Further tracker 104 includes a battery 132 arranged inside the housing 112 and connected to various electrical and electronic components of the tracker 104 to provide electric power to the components. In an embodiment, the battery 132 may be rechargeable battery and the tracker 104 includes suitable charging ports to charge the battery. In some embodiments, the battery 132 may include non-rechargeable batteries are replaced after the elapse of useful life.

Additionally, the tracker 104 includes a transceiver 134 to enable a communication and exchange of data between the tracker and an external device, for example, the web-based application 204 of the mobile phone of a technician and/or a central station 200. The transceiver 134 may be a short-range communication unit, for example, Bluetooth based transceiver, to enable communication between the tracker 104 and the mobile device of the technician. In some embodiments, the transceiver 134 may facilitate long range communication, for example, via internet, to enable communication between the tracker 104 and the central station 200.

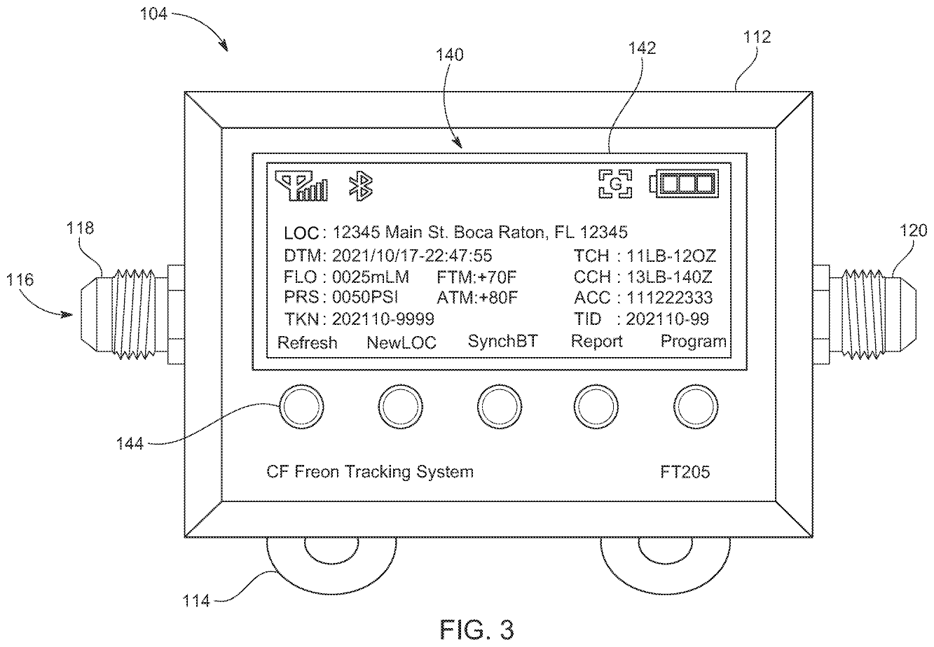

Moreover, as shown in FIG. 3, the tracker 104 includes a user interface 140 having a display 142 for showing/displaying various data, for example, amount of fluid being discharged through the conduit 116, the pressure of the fluid inside the conduit 116, a location of the tracker 104 (i.e., tank assembly 110) etc., to the technician or any other user in real time. The display 142 may also be adapted to show a data related to amount of gas remaining inside the tank 102. Further, a history of the locations of the tracker 104 at which the tracker 104 was stationary and/or locations at which the fluid is discharged from the tank 104 can be viewed via the display 142. The user interface 142 also facilitates in accessing a job ticket number associated with the discharge event of the fluid from the tank 102. The user interface 140 also facilitates an entry of a tank identification number of the tank 102 in the tracker 104 to which the tacker 104 is mounted.

To facilitate the tank identification number and any other date and access the historical data stored inside the tracker, the user interface 140 may include a keypad 144. In an embodiment, the technician may enter an identification number (i.e., job ticket number) associated with a job for filling the fluid in an appliance using the keypad 144. In an embodiment, the keypad 144 may be physical keypad with various keys arranged on the housing 112 of the tracker 104. In some embodiments, the keypad 144 may be a touch pad arranged on the display 142 of the tracker 104.

Moreover, referring back to FIG. 2, the tracker 104 may include a movement sensor 146, for example, an accelerometer, to determine traveling of the tank assembly 110 (i.e., the tracker 104) from one location to another location. Although the accelerometer is contemplated as the movement sensor 146, it may be appreciated that any other movement sensor may be utilized for detecting the traveling or stationary state of the tank assembly 110 (i.e., the tracker 104). In an embodiment, the tracker 104 may include a second temperature sensor 148 to detect an ambient temperature.

Further, the tracker 104 includes a controller 150 arranged in communication with various sensors, for example, the pressure sensor 124, the temperature sensor 126, the flow sensor 122, the location sensor 130, the movement sensor 146 of the tracker 104 and is adapted to receive the data with the sensors. In embodiment, the controller 150 is adapted to receive at least one of a flow rates of the gas, a pressure of the gas, or a temperature of the gas flowing through the conduit 116 from the at least one of the sensors 122, 124, 126, and is adapted to determine total amount of gas discharge through the conduit 116 during a discharge event. Further, the controller 150 is configured to determine a location of the tracker 104 (i.e., the tank assembly 110), based on the inputs from the location senor 130 and movement sensor 146, during a discharge event of the fluid from the tank 102 based on the inputs from the location sensor 130, and associates the location with the discharge event of the fluid from the tank 102. In an embodiment, the controller 150 is configured to record/store a date and time stamp associated with each discharge cycle or event. Also, the controller 150 stores the amount of fluid discharged from the tank 102 during each of the discharge events. Further, the controller 150 may check if a job ticket number is entered by the technician before a discharge event and associates the discharge event and the data collected during the discharge event with the job ticket number if the job ticket number is entered before initiating the discharge event.

Also, the controller 150 may update the data related to the remaining amount of fluid stored inside the tank 102 after each discharge event. Accordingly, based on the data received from the sensors 122, 124, 126, and other components of the tracker 104, the controller 150 may be adapted to control the operation of the tank assembly 110. Also, the controller 150 is in communication with the display 142 to display one or more operating parameters of the tank assembly 110 along with location of the tank assembly 110 in real time. For example, the display 142 is adapted to show the flow rate of the fluid, the pressure of the fluid, and the temperature of the fluid flowing through the conduit 116 in real time. The display 142 also shows the location coordinates of the tracker 104, and the ambient temperature. In an embodiment, the display 142 also indicates a remaining capacity of the battery 132 of the tracker. Also, the controller 150 is in communication with the mobile device 202 via the transceiver 134 and share all the data monitored and collected by the controller 150 to the mobile device 202 that can be seen by the operator through web-based application 204.

The controller 150 may include a processor 152 for executing specified instructions, which controls and monitors various functions associated with tank assembly 110. The processor 152 may be operatively connected to a memory 154 for storing instructions related to the monitoring of the tank assembly 110. In an embodiment, the memory 154 may also store various data, such as, tank identification number, flow rate of the fluid flowing through the conduit 116, pressure of the fluid flowing through the conduit 116, temperature of the fluid flow through the conduit 116, job ticket number, date and time stamp associated with each discharge event, location of tracker 104 associated with each discharge event, amount of fluid discharge during each discharge event, remaining amount fluid stored inside the tank 102 etc.

The memory 154 as illustrated is integrated into the controller 150, but those skilled in the art will understand that the memory 154 may be separate from the controller 150 but onboard the tracker 104, and/or remote from the controller 150 and the tracker 104, while still being associated with and accessible by the controller 150 to store information in and retrieve information from the memory 154 as necessary during the operation of tank assembly 110. Although the processor 152 is shown, it is also possible and contemplated to use other electronic components such as a microcontroller, an application specific integrated circuit (ASIC) chip, or any other integrated circuit device. Moreover, the controller 150 may refer collectively to multiple control and processing devices across which the functionality of the tracker 104 may be distributed. For example, the display 142, the transceiver 134, the movement sensor 146, the pressure senor 124, the flow sensor 122, the temperature sensor 126, the location sensor 130 may each have one or more controllers that communicate with the controller 150.

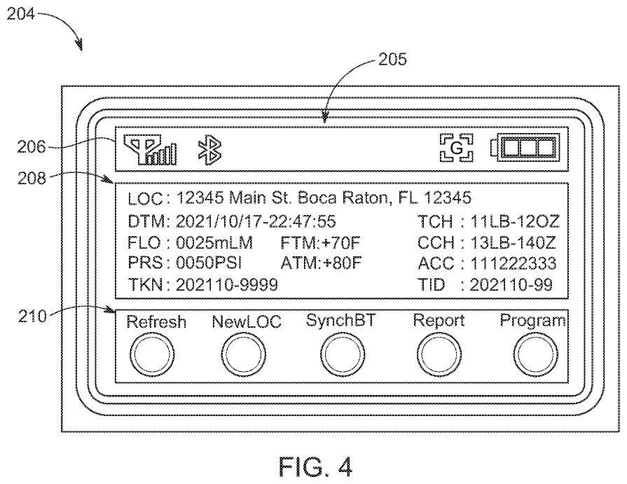

Referring to FIG. 4, the web-based application 204 installed on mobile device 202 of the technician is shown. The technician may access the central station 200 through the application 204. The application 204 on the mobile device 202 can communicate with the tracker 104 through the short-range communication, for example, Bluetooth or Wi-fi, etc. The application 204 receives the data from the tracker 104 and sends the data to the central station 200. Further, during the discharge event of the tank 102, the application may record the location data of the mobile device 202 and may share the location data with the central station 200. Also, during traveling or movement of the tank assembly 110 to the customer site, the application 204 keeps receiving the location of the tracker 104 at regular interval and check if the mobile device 202 is within a predetermined vicinity of the tracker 104. Further, as shown in FIG. 4, the web-based application 204 includes a user interface 205 (i.e., display 205) to display the data received from the tracker 104 during the discharge event or otherwise. In an embodiment, as shown in FIG. 4, the display 205 is similar to the display 142 of the tracker 104 and includes a status bar 206 that shows satellite strength, Bluetooth, and battery level. The display 205 also includes a measurement display section 208 that may display all the data measured by various sensors of the tracker 104 in real time. Accordingly, the tracker 104 may shares the data measured/monitored/determined by the tracker 104 in real time with the mobile device 202 vis the transceiver 134. In an embodiment, the measurement display section 208 may display the data upon completion of the discharge event. Additionally, the display 205 includes a menu section 210 having virtual buttons to facilitate an access of the historical data or any other data. Moreover, the menu section 210 facilitates in entering data, for example, the tank identification numbers, job ticket number, etc. in in the web-based application 204.

A method for tracking or monitoring a discharge of the fluid from the tank 102 is now described. The method includes mounting the tracker 104 to the tank 102 and inserting/storing a tank identification number inside the tracker 104. The tank identification number is stored inside the memory 154 by accessing the display 142 and the keypad 144 of the tracker 104. Upon receiving the tank identification number, the processor 152 (i.e., the controller 152) associates the tracker 104 with the tank 102. Also, the technician may enter the amount of fluid stored inside the tank 102. It may be appreciated that the tank 102 is fully filled with the fluid before providing the tank assembly 110 to the technician. In some embodiments, the processor 152 may access the central station to determine a capacity of the tank 102 and amount of the fluid stored inside the tank 102 by using the tank identification number. It may be appreciated that the central station 200 may store updated information related to the capacity and amount of fluid stored inside the tank 102. The data at the central station 200 may be updated manually upon filling the tank 102 or automatically upon usage of the tank 102 for filling the fluid in various appliances.

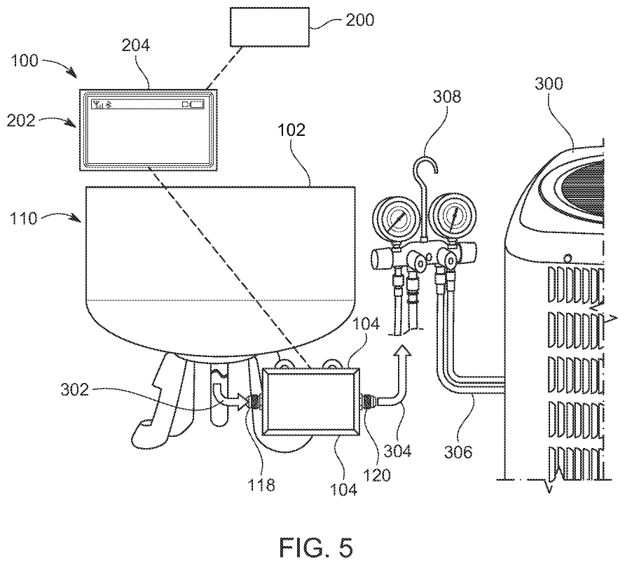

Upon reaching the customer site where the fluid needs to be filled in an appliance the technician receives a job ticket number from the customer. During traveling the mobile device 202 communicates with the tracker 104 and keeps receiving the location of tracker 104 form the processor 152. At the customer site, the technician enters the job ticket number inside the tracker 104 and/or the application 204. Subsequently, the processor 152 may determine whether the job ticket number matches with the various job ticket numbers stored inside the memory 154 or central station 200. Alternatively, the job ticket number is stored inside the tracker 104 and/or the application 204 for further analysis. Upon entering the job ticket number or otherwise, as shown in FIG. 5, the technician may engage the inlet of the tank 102 with the inlet portion 118 of the tracker 104 using a suitable pipe 302 and connects the outlet portion 120 of the tracker 104 to an appliance, for example, an appliance 300 via outlet pipes 304, 306 which include gauges 308, known in the art, to check the pressure and other parameters of the fluid being filling inside the appliance 300.

As the fluid starts to flow through the conduit 116, the flow sensor 122, the pressure sensor 1124, and/or the temperature sensor 126 monitors the flow rate, the pressure, and/or the temperature of the fluid, flowing through the conduit 116 and sends the data to the processor 152. Accordingly, the processor 152 detects an initiation of a discharge event of the fluid from the tank 102 and records the data, for example, the flow rate and the pressure of the fluid flowing through the conduit 116. Also, the processor 152 records the location of the tracker 104 during the discharge event and may associate the location of the tracker 104 with job ticket number and/or the discharge event. Upon filling the required amount of fluid to the appliance 300, the technician closes the tank valve, thereby stopping the flow of the fluid through the conduit 116. Accordingly, based on the data from the sensors 122, 124 during the discharge event, the processor 152 may determine an end of the discharge event. Also, based on the data from one or more of the sensors, for example, the flow sensor 122 and/or the pressure sensor 124, the processor 152 calculates/determines the total amount of fluid discharged from the tank 102 during the discharge event and stores the data in the memory 154. In an embodiment, the total amount of the gas discharged from the tank 102 is associated with the job ticket number if the job ticket number is entered before initiating the discharge event.

The processor 152 also stores the location of the tracker 104 during the discharge event and associate the location with the discharge event. In some embodiments, the processor 152 may also record and store a date and time stamp of the discharge event. In this manner, the processor 152 records amount fluid discharge at each discharge event and stores the corresponding location of the discharge event. The processor 152 shares this data with the mobile device 202 which then shares the data for the entire day to the central station 202 along with the tank identification number. In this manner, the total amount of the fluid discharged at each customer site can be tracked easily. In an embodiment, the location associated with each discharge event may be compared with actual locations of the customers. Accordingly, any unauthorized discharge of the fluid from the tank 102 can be detected. Also, tracking of the amount of fluid discharged at each customer site facilitates is billing each customer as per the amount of fluid filled. Accordingly, the owner of the AC repair business would have a better control on accounting and provide benefits to customer's relationship. Although the web-based application 204 is contemplated for sharing data from the tracker 104 to the central station 200, it may be appreciated that the tracker 104 may necessary hardware to facilitate a direct transfer of data from the tracker 104 to central station 200.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A tracker for monitoring a discharge of a fluid from a tank, the tracker comprising:
a conduit adapted to be fluidly connected with an outlet of the tank to supply the fluid to an appliance from the tank;
at least one sensor adapted to determine one or more parameters of the fluid flowing through conduit;
a location sensor adapted to detect a location of the tracker; and
a controller in communication with the flow sensor and the location sensor, the controller configured to
determine a discharge event of the fluid from the tank based on the one or parameters determined by the at least one sensor,
calculate a total amount of the fluid discharged from the tank based on the one or more parameters, determined by the at least one sensor, during the discharge event, and
determine a location of the tracker during the discharge event and associate the location of the tracker with the discharge event.

2. The tracker of claim 1, wherein the at least one sensor includes a flow sensor to determine a flow rate of the fluid through the conduit.

3. The tracker of claim 2, wherein the controller determines the total amount of fluid discharged from the tank during the discharge event based on the flow rate determined by the flow sensor.

4. The tracker of claim 1, wherein the tracker is associated with the tank by entering a tank identification number into the tracker.

5. The tracker of claim 1 further including a transceiver to facilitate a sharing of data measured by the tracker with a central station.

6. The tracker of claim 1 further including a user interface having a display to show at least one of a location of the tracker, the one or more parameters measured by the at least one sensor, and the total amount of fluid discharged from the tank.

7. The tracker of claim 1, wherein the at least one sensor includes a pressure sensor to monitor a pressure of the fluid flowing through the conduit.

8. The tracker of claim 1 further including an accelerometer to detect a movement of the tracker.

9. The tracker of claim 1, wherein the fluid is a refrigerant.

10. A tank assembly, comprising:
a tank adapted to store a fluid to facilitate a filling of the fluid in an appliance; and
a tracker mounted to the tank and adapted to monitor a discharge of the fluid from the tank, the tracker including
a conduit adapted to be fluidly connected with an outlet of the tank to supply the fluid to the appliance from the tank,
at least one sensor adapted to determine one or more parameters of the fluid flowing through conduit,
a location sensor adapted to detect a location of the tracker, and
a controller in communication with the at least one sensor and the location sensor, the controller configured to
determine a discharge event of the fluid from the tank based on the one or parameters determined by the at least one sensor,
calculate a total amount of the fluid discharged from the tank based on the one or more parameters, determined by the at least one sensor, during the discharge event, and
determine a location of the tracker during the discharge event and associate the location of the tracker with the discharge event.

11. The tank assembly of claim 10, wherein the at least one sensor includes a flow sensor to determine a flow rate of the fluid through the conduit.

12. The tank assembly of claim 11, wherein the controller determines the total amount of fluid discharged from the tank during the discharge event based on the flow rate determined by the flow sensor.

13. The tank assembly of claim 10, wherein the tracker is associated with the tank by entering a tank identification number into the tracker.

14. The tank assembly of claim 10, wherein the tracker includes a transceiver to facilitate a sharing of a data measured by the tracker with a central station.

15. The tank assembly of claim 10, wherein the tracker includes a user interface having a display to show at least one of a location of the tracker, the one or more parameters measured by the at least one sensor, and the total amount of fluid discharged from the tank.

16. The tank assembly of claim 10, wherein the at least one sensor includes a pressure sensor to monitor a pressure of the fluid flowing through the conduit.

17. The tank assembly of claim 10, wherein the tracker includes an accelerometer to detect a movement of the tracker.

18. The tank assembly of claim 10, wherein the fluid is a refrigerant.
